(19) United States
(12) Patent Application Publication
(10) Pub. No.: US 2021/0092195 A1
(43) Pub. Date: Mar. 25, 2021

(54) INFORMATION PUSH METHOD AND DEVICE

(71) Applicant: Baidu Online Network Technology (Beijing) Co., Ltd., Beijing (CN)

(72) Inventors: Zhongji Fan, Beijing (CN); Jian Xie, Beijing (CN)

(21) Appl. No.: 16/787,325

(22) Filed: Feb. 11, 2020

(30) Foreign Application Priority Data
Sep. 20, 2019 (CN) 201910895295.6

(51) Int. Cl. H04L 29/08; H04W 4/029; H04L 12/58

(52) U.S. Cl. CPC H04L 67/26; H04L 67/306; H04L 51/046; H04W 4/029; H04L 67/22; H04L 67/18

(57) ABSTRACT

An information push method and device are provided, relating to the technology field of data transmission. The detailed implementation solution is: acquiring a set of to-be-pushed information; determining to-be-pushed information corresponding to a push end from the set of to-be-pushed information, according to a triggering condition and historical behavior information of the push end associated with information on a target user; and pushing the to-be-pushed information corresponding to the push end, in a case that the triggering condition of the push end is triggered. In the application, a unified configuration and push of the to-be-pushed information is implemented for multiple push ends associated with the information on the target user, effectively improving gains of information push and the number of pushed information.

### CROSS-REFERENCE TO RELATED APPLICATION

This application claims priority to Chinese patent application No. 201910895295.6, filed on Sep. 20, 2019 and entitled “Information Push Method and Device”, which is hereby incorporated by reference in its entirety.

### TECHNICAL FIELD

The present application relates to the field of computer technology, and in particular, to the field of data transmission technology.

### BACKGROUND

An existing push end is usually configured with a separate push system. The push system is used to configure information to be pushed for the push end. However, when information on a user is associated with multiple push ends, due to the separate push system for the push end, it is unlikely to uniformly configure the information push strategy. Further, multiple push ends may push identical information to the same user. Moreover, if a push system only corresponds to one push end, it will lead to a single push channel, thus limiting the amount of information that can be pushed.

### SUMMARY

An information push method and device are provided according to embodiments of the present application, so as to solve one or more technical problems in the existing technology.

In a first aspect, an information push method is provided according to embodiments of the present application, and the method includes:

acquiring a set of to-be-pushed information:

determining to-be-pushed information corresponding to a push end from the set of to-be-pushed information, according to a triggering condition and historical behavior information of the push end associated with information on a target user; and

pushing the to-be-pushed information corresponding to the push end, in a case that the triggering condition of the push end is triggered.

In the embodiment, the unified configuration and push of the information to be pushed for multiple push ends associated with information on the target user can be achieved, effectively improving gains of information push and the amount of the pushed information.

In an embodiment, determining to-be-pushed information corresponding to a push end from the set of to-be-pushed information, according to a triggering condition and historical behavior information of the push end associated with information on a target user, includes:

acquiring a next triggering condition of the push end, historical pushing behavior information of the push end, and information on a current interest point of the target user; and

determining a plurality of pieces of to-be-pushed information corresponding to the push end, according to the next triggering condition of the push end, the historical pushing behavior information of the push end, the information on the current interest point of the target user, and a content of the to-be-pushed information in the set of to-be-pushed information;

wherein different push ends correspond to different pieces of to-be-pushed information.

In the embodiment, the unified configuration and push of the information to be pushed for multiple push ends associated with information on the target user can be achieved, effectively improving gains of information push and the amount of the pushed information.

In an embodiment, the method further includes:

acquiring a feedback result of pushed information from the push end; and

adjusting the triggering condition of the push end and/or the to-be-pushed information corresponding to the push end, according to the feedback result.

In the embodiment, the configured push information of the push end can be optimized and adjusted through the feedback result of the pushed information of the push end, so that each push end can push the to-be-pushed information that better satisfies the requirements of the target user.

In an embodiment, acquiring a set of to-be-pushed information, includes:

acquiring the set of to-be-pushed information according to at least one of real-time news information, user information, and recommendation information.

In this embodiment, real-time news information, user information and recommendation information can be used to obtain multi-dimensional to-be-pushed information, which improves the richness of the to-be-pushed information, and finally rendering the information pushed through the push end being more suitable for the target user.

In a second aspect, an information push device is provided according to embodiments of the present application, and the information push device includes:

a first acquiring module configured to acquire a set of information to be pushed;

a determining module configured to determine to-be-pushed information corresponding to a push end from the set of to-be-pushed information, according to a triggering condition and historical behavior information of the push end associated with information on a target user; and

a pushing module configured to push the to-be-pushed information corresponding to the push end, in a case that the triggering condition of the push end is triggered.

In an embodiment, the determining module includes:

an acquiring sub-module, configured to acquire a next triggering condition of the push end, historical pushing behavior information of the push end, and information on a current interest point of the target user; and

a determining sub-module configured to determine a plurality of pieces of to-be-pushed information corresponding to the push end, according to the next triggering condition of the push end, the historical pushing behavior information of the push end, the information on the current interest point of the target user, and a content of the to-be-pushed information in the set of to-be-pushed information;

wherein different push ends correspond to different pieces of to-be-pushed information.

In an embodiment, the device further includes:

a second acquiring module configured to acquire a feedback result of pushed information from the push end; and

an adjusting module configured to adjust the triggering condition of the push end and/or the to-be-pushed information corresponding to the push end, according to the feedback result.

In an embodiment, the first acquiring module is further configured to acquire the set of to-be-pushed information according to at least one of real-time news information, user information, and recommendation information.

In a third aspect, an electronic device is provided according to embodiments of the present application, the functions of the electronic device may be implemented by hardware or by executing corresponding software with hardware. The hardware or software includes one or more modules corresponding to the functions described above.

In a possible implementation, the structure of the electronic device includes a processor and a storage device, the storage device is configured to store a program for supporting the above information push method executed by the above information push device, and the processor is configured to execute the program stored in the storage device. The electronic device further includes a communication interface configured for communication between the electronic device and another apparatus or communication network.

In a fourth aspect, a non-volatile computer readable storage medium is provided for storing computer software instructions used by the electronic device, wherein the computer software instructions include programs involved in execution of the above information push.

An embodiment in the application above has the following advantages or beneficial effects. In the present application, a global configuration and push of information to be pushed in multiple push ends associated with the information on the target user can be achieved, which effectively improves the benefits of the pushed information and the amount of the pushed information. In the present application, technical means of filtering and configuring the information to be pushed for multiple push ends associated with the information on the target user is applied, so that a technical effect of pushing different information through different push ends and thereby improving the information push benefits and the amount of the pushed information is achieved. Technical problems of repeated push information through different push ends and a limited amount of the pushed information in the existing technology are overcome, thus improving a user stickiness to the push ends.

Other effects of above alternative methods will be described below in combination with specific embodiments.

### BRIEF DESCRIPTION OF THE DRAWINGS

The attached drawings are used for a better understanding of the scheme, and do not constitute a limitation of the application, wherein:

FIG. 1 is a flow diagram of an information push method according to a first embodiment of the present application;

FIG. 2 is a flow diagram of step S200 of an information push method according to a first embodiment of the application:

FIG. 3 is a flow diagram of another information push method according to a first embodiment of the present application;

FIG. 4 is a flow diagram of another information push method according to a first embodiment of the present application:

FIG. 5 is an application diagram of an information push method according to a first embodiment of the present application;

FIG. 6 is a schematic diagram of an information push device according to a second embodiment of the present application:

FIG. 7 is a schematic diagram of a determination module of an information push device according to a second embodiment of the present application;

FIG. 8 is a schematic diagram of another information push device according to a second embodiment of the present application:

FIG. 9 is a block diagram of an electronic device for implementing an information push method according to an embodiment of the present application.

### DETAILED DESCRIPTION OF THE EMBODIMENTS

The exemplary embodiments of the present application will be described below in combination with the accompanying drawings, including various details of the embodiments of the present application to facilitate understanding, which should be considered as exemplary only. Therefore, those of ordinary skill in the art should realize that various changes and modifications can be made to the embodiments described herein without departing from the scope and spirit of the present application. Similarly, for clarity and simplicity, the following description omits the description of the public function and structure.

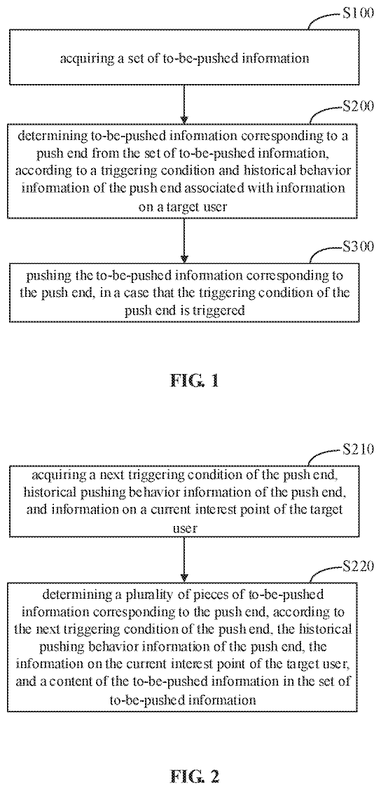

According to a first embodiment of the application, an information push method is provided according to the present application. As shown in FIG. 1, the information push method may include S100 to S300.

S100: acquiring a set of to-be-pushed information.

The to-be-pushed information in the set of to-be-pushed information can include a content in which a target user is interested, a content associated with the target user (for example, the information for reminding, scheduling information), a content customized by the target user, a public emergency notice, a news content, the pushed advertisement of a service end, a running content, etc. Specific push information can be selected and adjusted as required.

The to-be-pushed information in the set of to-be-pushed information can be derived from different data sources. Specific data sources can be selected as required. For example, the to-be-pushed information can be acquired from an advertising data source, a user information data source of the target user, an operation content data source of the service end, and a news data source.

The to-be-pushed information can be acquired directly from the data source, or it can be mined from a network resource or a data source based on historical behaviors of the target user, interest points of the target user, a push strategy of the push system, etc.

S200: determining to-be-pushed information corresponding to a push end from the set of to-be-pushed information, according to a triggering condition and historical behavior information of the push end associated with information on a target user.

The push end associated with the information on the target user can include multiple push ends registered and associated through identical information on the target user. It can also include multiple push ends registered and associated through different information associated with the target user. For example, a first push end may be a push end associated with a mailbox of the target user A, a second push end may be a push end associated with a mobile phone number of the target user A, and a third push end may be a push end associated with an identity certificate of the target user A. The three push ends can be used as the multiple push ends associated with the information on the target user.

The push end can include hardware and/or software capable of pushing information. For example, the push end can include an audio device (for example, an intelligent speaker), a screen device (for example, a mobile terminal), an app (application, application program), etc.

The triggering condition of the push end can include a preset time point before the target user waking up the push end for an interaction, a preset time point after an interaction between the target user and the push end, a time point, for a timing information push, of a timer of the push end, and a time point when an emergency event occurs, etc. The emergency event can include a sudden natural disaster warning, an emergency events customized by the target user, etc.

The historical behavior information can include the generated push behavior information of each push end. It can also include work behavior information of each push end. For example, the historical information may include voice interaction behaviors between the smart speaker and the target user, broadcast behaviors generated by the smart speaker, operation behaviors of the target user generated by an app, and information push behaviors generated by an app, etc. Historical behavior information can be used as a reference factor for each push end to configure the to-be-pushed information, so as to select the to-be-pushed information that better matches the target user at the current time for different push ends.

S300: pushing the to-be-pushed information corresponding to the push end, in a case that the triggering condition of the push end is triggered.

In an example, the amount of the information that can be pushed by a push end can be determined according to preset requirements of the target user and features of the push end. For example, if the target user sets that the push end can only push two pieces of information at a time, the piece number of information of the push end at a time cannot exceed two. For another example, in a case of a push end with a feature of a low disturbance degree (the disturbance degree every day is pushing information once a day), the to-be-pushed information cannot be sent again if the push end has already sent a piece of to-be-pushed information in a day.

The embodiment can implement the unified configuration and push of the information to be pushed for multiple push ends associated with the target user information, effectively improve the gains of information push and the amount of the pushed information.

In an embodiment, as shown in FIG. 2, determining to-be-pushed information corresponding to a push end from the set of to-be-pushed information, according to a triggering condition and historical behavior information of the push end associated with information on a target user, may include S210 to S220.

S210: acquiring a next triggering condition of the push end, historical pushing behavior information of the push end, and information on a current interest point of the target user.

The information on a current interest point of the target user can include the information that the target user may be currently interested in according to historical interaction behaviors of the target user, feedback behaviors to historical push information and so on.

In an example, after the interaction between the push end and the target user, the preset time point can be used as the next triggering condition of the push end. If the push end completes an information push at a first predetermined time point of the timer, a second predetermined time point of the timer (a time point after the first predetermined time point) can be the next triggering condition of the push end.

S220: determining a plurality of pieces of to-be-pushed information corresponding to the push end, according to the next triggering condition of the push end, the historical pushing behavior information of the push end, the information on the current interest point of the target user, and a content of the to-be-pushed information in the set of to-be-pushed information, wherein different push ends correspond to different pieces of to-be-pushed information.

In this embodiment, according to the triggering condition, the historical pushing behavior information, the information on the current interest point of the target user, and the content of the to-be-pushed information, it is possible to accurately determine different to-be-pushed information for various push ends. Therefore, not only gains of the information push can be maximized, but also the amount of push information can be improved.

In an example, if the next triggering condition of the push end is met, the historical pushing behavior information of the push end shows that music has been pushed to the target user, and the information on a current interest point of the target user includes music, the information related to music is acquired from the set of to-be-pushed information as the to-be-pushed information of the push end.

In one example, if the next triggering condition of the push end is met, the historical pushing behavior information of the push end shows that movie playing information has been pushed to the target user, and the information on a current interest point of the target user includes movies, the information related to music in the set of to-be-pushed information will be filtered out and will not be regarded as the to-be-pushed information of the push end. Because the historical pushing behavior information of the push end show that movie content of immersive consumption is pushed to the target user, the target user may be watching a movie at present. Therefore, it is not suitable to push the information related to music to the user in the process of enjoying (when user is watching the movie).

In an embodiment, after the step S220, the information push method further includes:

according to a current feature of the push end, contents of the corresponding multiple pieces of to-be-pushed information, a context feature of the push end (interaction information between the push end and the target user at the last moment), and the user information, ranking the multiple pieces of to-be-pushed information corresponding to each push end in a matching degree. The to-be-pushed information with the highest matching degree is pushed to the target user in advance.

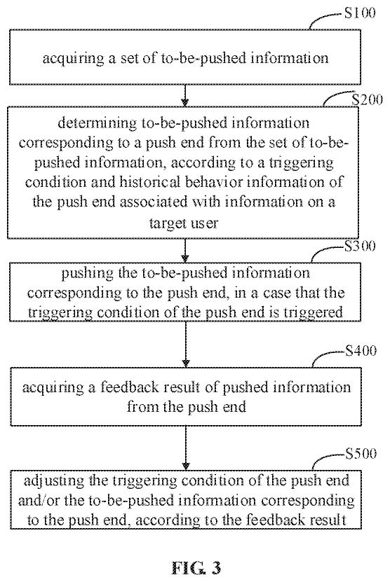

In an embodiment, as shown in FIG. 3, the information push method further includes S400 and S500.

S400: acquiring a feedback result of pushed information from the push end.

In an example, information regarding whether the target user responded to the pushed information can be used as an indicator to determine the feedback result. For example, the information of the target user clicking and viewing the pushed information, the target user not clicking and viewing the pushed information, the target user listening to full of the pushed voice information as broadcast, and the target user breaking off the broadcast of the pushed voice information, etc.

S500: adjusting the triggering condition of the push end and/or the to-be-pushed information corresponding to the push end, according to the feedback result. A weight of the to-be-pushed information related to the pushed information which is broken off or unchecked is reduced, so that when configuring a subsequent information push for a push end, this to-be-pushed information is filtered out or the amount of this to-be-pushed information is reduced.

In this embodiment, according to the feedback result of pushed information from the push end, the configured to-be-pushed information of the push end is optimized and adjusted, so that it is possible to push the to-be-pushed information that better matches the requirements of the target user by the push end.

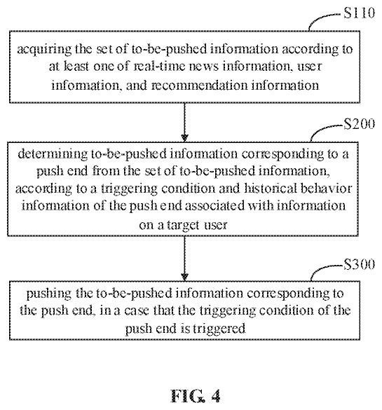

In an embodiment, as shown in FIG. 4, acquiring a set of to-be-pushed information includes S110.

S110: acquiring the set of to-be-pushed information according to at least one of real-time news information, user information, and recommendation information.

The user information can include information associated with the target user. For example, scheduling information of the target user, to-be-reminded information set by the target user, and the like. The recommendation information can include advertisement information, announcement information, and operation information that is required to be pushed to the target user by the server.

In this embodiment, real-time news information, user information and recommendation information can be used to obtain multi-dimensional to-be-pushed information, thus improving the richness of the to-be-pushed information, and finally rendering the pushed information through the push end more suitable for the target user.

In an example, solutions in the embodiments above can be applied in a push system, and the push system controls multiple push ends in different dimensions to perform the information push. A specific implementation is shown as follows.

The set of to-be-pushed information is acquired by the push system.

The to-be-pushed information for a push end is determined, by the push system, from the set of to-be-pushed information according to the triggering condition and historical behavior information of the push end associated with the information on the target user.

When the triggering condition of the push end is triggered, the to-be-pushed information for the push end is pushed, by the push system, to the target user.

The feedback result of the pushed information of the push end is acquired by the push system.

The triggering condition of the push end and/or the to-be-pushed information for push end is adjusted, by the push system according to the feedback result.

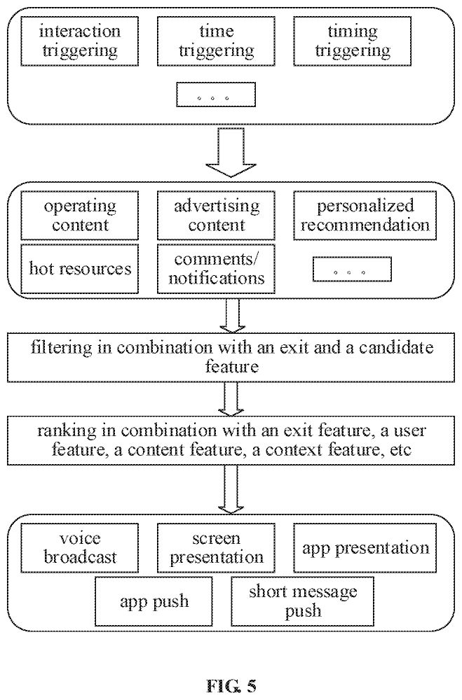

In an example, as shown in FIG. 5, the solution described in any of the above embodiments can be implemented by the following modules.

A triggering module is configured to execute the triggering condition in the step S200. The triggering condition includes an interaction triggering between the user and the push end, an event triggering generated by an emergency event, and a timing triggering generated periodically by a timer on the push end.

A recalling module is configured to acquire the set of to-be-pushed information in the step S100. The recalling module can be configured to acquire the operating content, advertising content, user personalized recommendation content, hot resource content, and user notification and comments content, etc.

A filtering module is configured to determine the to-be-pushed information corresponding to the push end from the set of to-be-pushed information in the step S200. The filtering module is configured to, in combination with a feature of the push end and the recalled candidate to-be-pushed information, calculate a matching degree and filter the candidate to-be-pushed information according to the matching degree.

A ranking module is configured to rank the to-be-pushed information filtered by the filtering module, in combination with the feature of the push end, a user feature, a context feature, and a content feature of the to-be-pushed information.

A transmitting and feeding-back module is configured to execute the step S30 and S400. It is configured to push the to-be-pushed information to users through different push ends, such as voice broadcast, screen presentation, app presentation, app push, and short message push, and record the feedback result of the pushed information transmitted from different push ends.

In an example, scenarios where to-be-pushed information can be pushed include: Before or after TTS (Text To Speech) during conversation interaction, screens of screened devices (including screen savers, bottom hint during fulfillment), homefeeds cards in standby state), device-related apps (App push information on the mobile terminal, push on the App's user interface), SMS push notifications related to mobile phone numbers related to device registration accounts, etc.

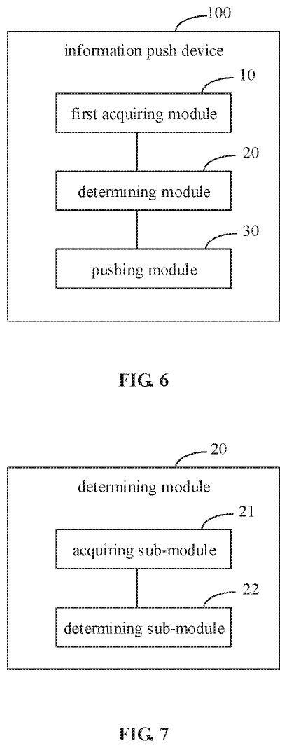

According to a second embodiment of the present application, an information push device is provided according to the present application. As shown in FIG. 6, the information push device 100 includes:

a first acquiring module 10 configured to acquire a set of information to be pushed;

a determining module 20 configured to determine to-be-pushed information corresponding to a push end from the set of to-be-pushed information, according to a triggering condition and historical behavior information of the push end associated with information on a target user; and

a pushing module 30 configured to push the to-be-pushed information corresponding to the push end, in a case that the triggering condition of the push end is triggered.

In an embodiment, the first acquiring module is further configured to acquire the set of to-be-pushed information according to at least one of real-time news information, user information, and recommendation information.

In an embodiment, as shown in FIG. 7, the determining module 20 includes:

an acquiring sub-module 21 configured to acquire a next triggering condition of the push end, historical pushing behavior information of the push end, and information on a current interest point of the target user; and

a determining sub-module 22 configured to determine a plurality of pieces of to-be-pushed information corresponding to the push end, according to the next triggering condition of the push end, the historical pushing behavior information of the push end, the information on the current interest point of the target user, and a content of the to-be-pushed information in the set of to-be-pushed information;

wherein different push ends correspond to different pieces of to-be-pushed information.

In an embodiment, as shown in FIG. 8, the information push device 100 further includes:

a second acquiring module 40 configured to acquire a feedback result of pushed information from the push end; and

an adjusting module 50 configured to adjust the triggering condition of the push end and/or the to-be-pushed information corresponding to the push end, according to the feedback result.

The information push device in the embodiment of the present application can implement the functions in any one of the embodiments of information push method above.

According to an embodiment of the present application, an electronic device and a readable storage medium are further provided according to the present application.

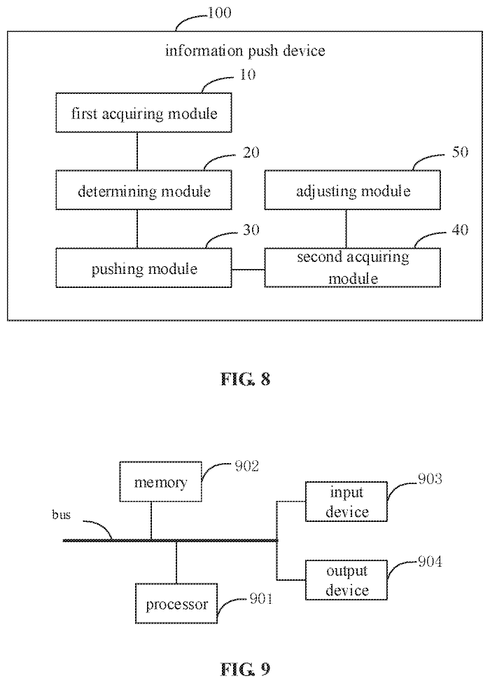

As shown in FIG. 9, it is a block diagram of an electronic device according to an information push method according to an embodiment of the present application. Electronic devices are intended to represent various forms of digital computers, such as laptop computers, desktop computers, workbenches, personal digital assistants, servers, blade servers, mainframe computers, and other suitable computers. Electronic devices can also represent various forms of mobile devices, such as personal digital processing, cellular phones, smart phones, wearable devices, and other similar computing devices. The components shown here, their connections and relationships, and their functions are merely examples, and are not intended to limit the implementation of the application described and/or required herein.

As shown in FIG. 9, the electronic device includes: one or more processors 901, a memory 902, and interfaces for connecting various components, including a high-speed interface and a low-speed interface. The various components are interconnected with different buses and can be mounted on a public mainboard or otherwise installed as required. The processor can process instructions executed within the electronic device, including instructions storing in or on a memory to display a graphical user interface (GUI) on an external input/output device (such as a display device coupled to the interface). In other embodiments, multiple processors and/or multiple buses can be used with multiple memories and multiple memories, if desired. Similarly, multiple electronic devices can be connected, each providing some of the necessary operations (for example, as a server array, a group of blade servers, or a multiprocessor system). A processor 901 is taken as an example in FIG. 9.

The memory 902 is a non-transitory computer readable storage medium provided by the present application. The memory stores instructions executable by at least one processor, so that at least one processor executes the information push method provided in the present application. The non-transitory computer readable storage medium of the present application stores computer instructions, which are used to have a computer to implement an information push method provided by this application.

As a non-transitory computer readable storage medium, the memory 902 can be used to store non-transitory software programs, non-transitory computer executable programs, and modules, such as program instructions/modules corresponding to the information push method in the embodiments of the present application (for example, The first acquiring module 10, the determining module 20, and the push module 30 shown in FIG. 6). The processor 901 executes various functional applications and data processing of the server by running non-transitory software programs, instructions, and modules stored in the memory 902, that is, a method for implementing information push in the embodiments of the foregoing method can be implemented.

The memory 902 can include a storage program area and a storage data area, where the storage program area can store an operating system and applications required for at least one function; the storage data area can store the data created according to the use of the electronic device of the information push method, etc., and the like. In addition, the memory 902 can include a high-speed random access memory, and can also include a non-transitory memory, such as at least one magnetic disk storage device, a flash memory device, or other non-transitory solid-state storage device. In some embodiments, the memory 902 can alternatively include a memory remotely set relative to the processor 901, and these remote memories can be connected to the information push electronic device through a network. Examples of the above network include, but are not limited to, the Internet, an intranet, a local area network, a mobile communication network, and combinations thereof.

The electronic device of the information push method can further include an input device 903 and an output device 904. The processor 901, the memory 902, the input device 903, and the output device 904 can be connected through a bus or in other ways. In FIG. 9, the connection through the bus is taken as an example.

The input device 903 can receive inputted numeric or character information, and generate key signal inputs related to user settings and function control of the information push electronic device, such as a touch screen, a keypad, a mouse, a trackpad, a touchpad, a pointing stick, one or multiple mouse buttons, trackballs, joysticks and other input devices. The output device 904 can include a display device, an auxiliary lighting device (for example, an LED), a haptic feedback device (for example, a vibration motor), and the like. The display device can include, but is not limited to, a liquid crystal display (Liquid Crystal Display, LCD), a light emitting diode (Light Emitting Diode, LED) display, and a plasma display. In some embodiments, the display device can be a touch screen.

Various implementations of the systems and technologies described herein can be implemented in digital electronic circuit systems, integrated circuit systems, application specific integrated circuits (ASICs), computer hardware, firmware, software, and/or combinations thereof. These various embodiments can include: implementation in one or more computer programs that are executable and/or interpreted on a programmable system including at least one programmable processor, which can be a dedicated or general-purpose programmable processor that can receive data and instructions from a storage system, at least one input device, and at least one output device, and transmit data and instructions to the storage system, at least one input device, and at least one output device.

These computing programs (also known as programs, software, software applications, or code) include machine instructions of a programmable processor and can be implemented using high-level procedures and/or object-oriented programming languages, and/or assembly/machine languages. As used herein, the terms “machine readable medium” and “computer readable medium” refer to any computer program product, device, and/or device used to provide machine instructions and/or data to a programmable processor (for example, magnetic disks, optical disks, memories, and programmable logic devices (PLDs)), include machine readable media that receives machine instructions as machine-readable signals. The term “machine-readable signal” refers to any signal used to provide machine instructions and/or data to a programmable processor.

In order to provide interaction with the user, the systems and techniques described herein can be implemented on a computer that has a display device (for example, CRT (Cathode Ray Tube) or LCD (Liquid Crystal Display) monitor for displaying information to the user; and a keyboard and pointing device (for example, a mouse or trackball) through which the user can provide input to the computer. Other kinds of devices can also be used to provide interaction with the user; for example, the feedback provided to the user can be any form of sensory feedback (for example, visual feedback, auditory feedback, or haptic feedback); and can be in any form (including acoustic input, voice input, or tactile input) to receive input from the user.

The systems and technologies described herein can be implemented in a subscriber computer of a computing system including background components (for example, as a data server), or a computing system including middleware components (for example, an application server), or a computing system including front-end components (for example, a user computer with a graphical user interface or a web browser, through which the user can interact with the implementation of the systems and technologies described herein), or include such background components, middleware components, or any combination of front-end components. The components of the system may be interconnected by any form or medium of digital data communication (for example, a communication network). Examples of communication networks include: a local area network (LAN), a wide area network (WAN), and the Internet.

The computer system can include clients and servers. The client and server are generally remote from each other and typically interact through a communication network. The client-server relationship is generated by computer programs running on the respective computers and having a client-server relationship with each other.

This application can implement unified configuration and the push of information to be pushed on multiple push terminals associated with target user information, which effectively improves the gains of push information and the amount of push information. This application adopts the technical means of filtering and configuring the information to be pushed for multiple push ends associated with the target user information, so that the technical effect of pushing different information through different push ends, thereby improving the information push gains and the amount of information push, is achieved. It overcomes the technical problems of repeated push information of different push ends and the amount of push information is limited in the prior art. It improves the user stickiness to the push end.

According to the technical solution of the embodiment of the present application, the present application overcomes the problem in the two-dimensional plane because the technical means of constructing the behavior trajectory in the space-time coordinate system by using position information and time information, and calculating the similarity between the two behavior trajectories based on the minimum editing distance when constructing and analyzing the behavior trajectory in the coordinate system, the technical problem of time factor is ignored, and the technical effect of acquiring the similarity of the behavior trajectory of the target object can be achieved more accurately.

It should be understood that the various forms of processes shown above can be used to reorder, add, or delete steps. For example, the steps described in this application can be executed in parallel, sequentially, or in different orders. As long as the desired results of the technical solutions disclosed in this application can be achieved, there is no limitation herein.

The specific embodiments above do not constitute a limitation on the protection scope of the present application. It should be understood by those skilled in the art that various modifications, combinations, sub-combinations and substitutions can be made according to design requirements and other factors. Any modification, equivalent replacement and improvement made within the spirit and principle of this application shall be included in the protection scope of this application.

What is claimed is:

1. An information push method, comprising:
acquiring a set of to-be-pushed information;
determining to-be-pushed information corresponding to a push end from the set of to-be-pushed information, according to a triggering condition and historical behavior information of the push end associated with information on a target user; and
pushing the to-be-pushed information corresponding to the push end, in a case that the triggering condition of the push end is triggered.

2. The information push method according to claim 1, wherein determining to-be-pushed information corresponding to a push end from the set of to-be-pushed information, according to a triggering condition and historical behavior information of the push end associated with information on a target user, comprising:
acquiring a next triggering condition of the push end, historical pushing behavior information of the push end, and information on a current interest point of the target user; and
determining a plurality of pieces of to-be-pushed information corresponding to the push end, according to the next triggering condition of the push end, the historical pushing behavior information of the push end, the information on the current interest point of the target user, and a content of the to-be-pushed information in the set of to-be-pushed information;
wherein different push ends correspond to different pieces of to-be-pushed information.

3. The information push method according to claim 1, further comprising:
acquiring a feedback result of pushed information from the push end; and
adjusting the triggering condition of the push end and/or the to-be-pushed information corresponding to the push end, according to the feedback result.

4. The information push method according to claim 1, wherein acquiring a set of to-be-pushed information, comprising:
acquiring the set of to-be-pushed information according to at least one of real-time news information, user information, and recommendation information.

5. An information push device, comprising:
one or more processors; and
a storage device configured for storing one or more programs, wherein
the one or more programs are executed by the one or more processors to enable the one or more processors to:
acquire a set of information to be pushed;
determine to-be-pushed information corresponding to a push end from the set of to-be-pushed information, according to a triggering condition and historical behavior information of the push end associated with information on a target user; and
push the to-be-pushed information corresponding to the push end, in a case that the triggering condition of the push end is triggered.

6. The information push device according to claim 5, wherein the one or more programs are executed by the one or more processors to enable the one or more processors further to:
acquire a next triggering condition of the push end, historical pushing behavior information of the push end, and information on a current interest point of the target user; and
determine a plurality of pieces of to-be-pushed information corresponding to the push end, according to the next triggering condition of the push end, the historical pushing behavior information of the push end, the information on the current interest point of the target user, and a content of the to-be-pushed information in the set of to-be-pushed information;
wherein different push ends correspond to different pieces of to-be-pushed information.

7. The information push device according to claim 5, wherein the one or more programs are executed by the one or more processors to enable the one or more processors further to:
acquire a feedback result of pushed information from the push end; and
adjust the triggering condition of the push end and/or the to-be-pushed information corresponding to the push end, according to the feedback result.

8. The information push device according to claim 5, wherein the one or more programs are executed by the one or more processors to enable the one or more processors further to acquire the set of to-be-pushed information according to at least one of real-time news information, user information, and recommendation information.

9. A non-transitory computer readable storage medium, storing a computer executable instructions stored thereon, that when executed by a processor cause the processor to perform operations comprising:
acquiring a set of to-be-pushed information;
determining to-be-pushed information corresponding to a push end from the set of to-be-pushed information, according to a triggering condition and historical behavior information of the push end associated with information on a target user; and
pushing the to-be-pushed information corresponding to the push end, in a case that the triggering condition of the push end is triggered.

10. The non-transitory computer-readable storage medium of claim 9, wherein the computer executable instructions, when executed by a processor, cause the processor to perform further operations comprising:
acquiring a next triggering condition of the push end, historical pushing behavior information of the push end, and information on a current interest point of the target user; and
determining a plurality of pieces of to-be-pushed information corresponding to the push end, according to the next triggering condition of the push end, the historical pushing behavior information of the push end, the information on the current interest point of the target user, and a content of the to-be-pushed information in the set of to-be-pushed information;
wherein different push ends correspond to different pieces of to-be-pushed information.

11. The non-transitory computer-readable storage medium of claim 9, wherein the computer executable instructions, when executed by a processor, cause the processor to perform further operations comprising:
acquiring a feedback result of pushed information from the push end; and
adjusting the triggering condition of the push end and/or the to-be-pushed information corresponding to the push end, according to the feedback result.

12. The non-transitory computer-readable storage medium of claim 9, wherein the computer executable instructions, when executed by a processor, cause the processor to perform further operations comprising:
acquiring the set of to-be-pushed information according to at least one of real-time news information, user information, and recommendation information.
